(19) United States
(12) Patent Application Publication
(10) Pub. No.: US 2024/0396693 A1
(43) Pub. Date: Nov. 28, 2024

(54) DETECTION OF A CONTROL RESOURCE SET IN A COMMUNICATION NETWORK

(71) Applicant: Nokia Technologies Oy, Espoo (FI)

(72) Inventors: Sami-Jukka HAKOLA, Oulu (FI); Esa Tapani TIIROLA, Oulu (FI); Kari Juhani HOOLI, Oulu (FI); Jorma Johannes KAIKKONEN, Oulu (FI); Pasi Eino Tapio KINNUNEN, Oulu (FI)

(21) Appl. No.: 18/693,814

(22) PCT Filed: Sep. 23, 2022
(86) PCT No.: PCT/FI2022/050643

§ 371 Date: Mar. 20, 2024

(30) Foreign Application Priority Data
Oct. 1, 2021 (FI) 20216019

(51) Int. Cl. H04L 5/00; H04B 7/06; H04W 72/23

(52) U.S. Cl. CPC H04L 5/0053; H04B 7/06968; H04W 72/23

(57) ABSTRACT

There is provided an apparatus for detecting a control resource set of index 0. CORESET #0, which is configured to carry information for initial access to a communication network. The apparatus is configured to identify a special configuration for at least one search space associated to the CORESET #0, and the apparatus is configured to determine an extended search space set based on the identified special configuration.

Various example embodiments relate to a method, an apparatus, a computer program product and computer executable instructions for detection of a control resource set carrying initial access information in a communication network enabling narrowband communication, for example at bandwidth below 5 MHz.

### BACKGROUND

Many different scenarios are emerging in which it may be beneficial to enable the operation of 5G NR in a narrower bandwidth than the 5 MHz channels, for example down to 3 MHz. As an example, for soft migration deployment of NR in 900 MHz Future Railway Mobile Communication System, FRMCS, band takes place parallel with an existing Global System for Mobile Communications-Railway, GSM-R, which is an international wireless communications standard for railway communications and applications. GSM-R carriers within a 5.6 MHz bandwidth permits about 3.6 MHz to be used for the parallel NR. There are other cases and examples, where only about 3 MHz channels are available for NR. Signals and channels of the synchronization signal, SS/physical broadcast channel, PBCH, block, SSB, transmitted by NR base stations, gNBs, were not initially designed for transmission in such narrow channels.

### SUMMARY

Monitoring and detecting initial access data in a communication network, especially in narrowband, is enabled.

According to some aspects, there is provided the subject-matter of the independent claims. Some example embodiments are defined in the dependent claims. The scope of protection sought for various example embodiments is set out by the independent claims. The example embodiments and features, if any, described in this specification that do not fall under the scope of the independent claims are to be interpreted as examples useful for understanding various example embodiments.

According to a first aspect, there is provided an apparatus detecting a control resource set of index 0, CORESET #0, which is configured to carry information for initial access to a communication network. The apparatus is configured to identify a special configuration for at least one search space associated to the CORESET #0, and the apparatus is configured to determine an extended search space set based on the identified special configuration.

According to a second aspect the apparatus comprises at least one processor, and at least one memory including computer program code, that at least one memory and the computer program code configured to, with the at least one processor, cause the performance of the apparatus.

According to a third aspect, there is provided a method for detecting a control resource set of index 0, CORESET #0, which is configured to carry information for initial access to a communication network. The method comprises identifying a special configuration for at least one search space associated to the CORESET #0, and determining an extended search space set based on the identified special configuration.

According to fourth aspect, there is provided a computer program configured to cause a method in accordance with the third aspect to be performed.

According to fifth aspect, there is provided a non-transitory computer readable medium comprising program instructions that, when executed by at least one processor, cause an apparatus at least: to identify a special configuration for at least one search space associated to a control resource set of index 0, CORESET #0, which is configured to carry information for initial access to a communication network; and to determine an extended search space set based on the identified special configuration.

### BRIEF DESCRIPTION OF THE DRAWINGS

FIG. 1 shows, by way of a simplified example, a communication system;

FIG. 2 shows, by way of example, NR synchronization signal blocks, SSBs;

FIG. 3a shows, by way of example, CORESETs with different channel bandwidths;

FIG. 3b shows examples of punctured CORESETs;

FIG. 4 shows, by way of example, Type0-PDCCH monitoring occasions;

FIG. 5 shows, by way of example, an extended search space set for a Type0-PDCCH;

FIG. 6 shows, by way of example, a block diagram of an apparatus; and

FIG. 7 shows, by way of example, a flow chart of a method for a mobile device.

The scope of protection sought for various embodiments of the invention is set out by the independent claims. The embodiments, examples, drawings and features, if any, described in the specification that do not fall under the scope of the independent claims are to be interpreted as examples useful for understanding various embodiments of the invention.

### DETAILED DESCRIPTION

It is enabled to enhance detection performance or coverage of initial access information, as carried in a physical downlink control channel, PDCCH, transmitted via a control resource set, CORESET, of a communication network. This applies especially on a narrow transmission bandwidths of below 5 MHz. A UE is configured to identify a special configuration of CORESETs. The UE is configured to determine an extended search space set based on the identified special configuration. The extended search space set comprises search spaces of two or more CORESETs. Detection of initial access information is enhanced by monitoring CORESETs based on the determined extended search space set.

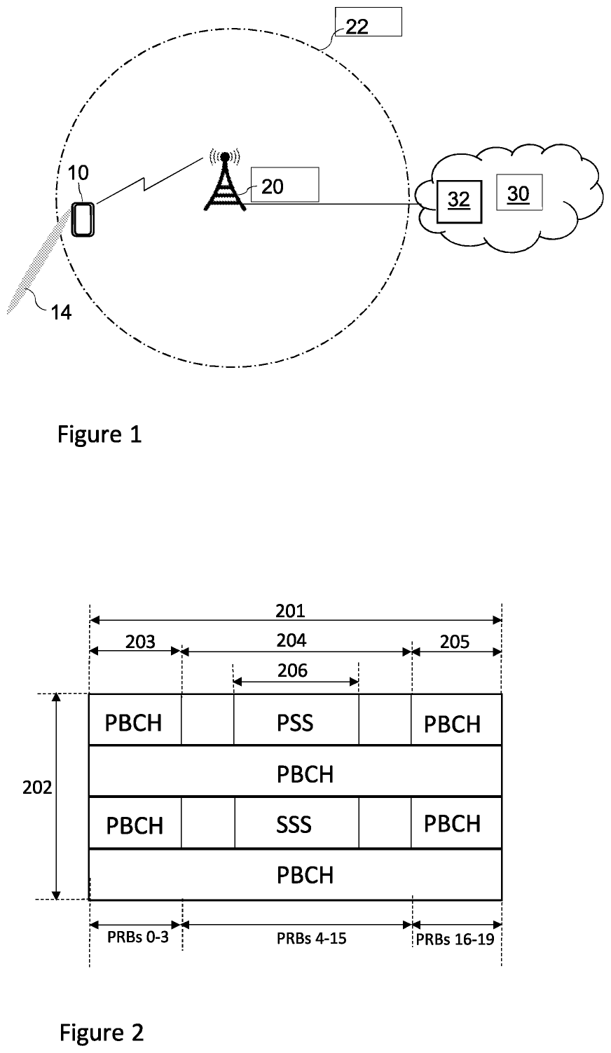

FIG. 1 shows, by way of a simplified example, a communication system. There may be a beam-based wireless communication system, which comprises a user equipment, UE, 10, one or more base stations, BSs, 20. A UE 10 may be connected to a BS 20 via air interface using beam 14. For a network frequencies below 1 GHz and transmission bandwidths below 5 MHz, the BS 20 may be configured to utilize a sector-wide beam, and the UE 10 may be configured to utilize an omnidirectional beam, or a sector-wide beam, of two sectors, for example. A BS 20 may be a network entity that configures some or all control information of a UE 10 and allocates resources for a UE 10. In some example embodiments, BS may refer to a transmission or reception point, TRP, or comprise multiple TRPs that may be co-located or non-co-located. The term transmission or reception point (TRP) herein generally refers to a point capable for transmission and/or reception, without limiting to the 3GPP NR TRP. In a multi-TRP scenario two or more BSs are considered as TRPs. One or multiple beams per TRP may be used to cover a cell or provide coverage for a cell or multiple cells.

A UE 10 may be referred to as a user device or wireless terminal in general. Hence, without limiting to Third Generation Partnership Project (3GPP) User Equipment, the term user equipment/UE is to be understood broadly to cover various mobile/wireless terminal devices, mobile stations and user devices for user communication and/or machine to machine type communication. A UE 10 may comprise, for example, a smartphone, a cellular phone, a Machine-to-Machine, M2M, node, Mobile Termination-part of integrated access and backhaul, IAB, node, Machine-Type Communications, MTC, node, an Internet of Things, IoT, node, a car telemetry unit, a laptop computer, a tablet computer or, indeed, another kind of suitable wireless terminal.

In the example system of FIG. 1, UE 10 may communicate wirelessly with a cell of BS 20 via at least one beam 14. The BS 20 may be considered as a serving BS for the UE 10 and the cell of the BS 20 may be a serving cell for the UE 10. Air interface between a UE 10 and a BS 20 may be configured in accordance with a radio access technology, RAT, which both UE 10 and BS 20 are configured to support. Examples of cellular RATs include Long Term Evolution, LTE, New Radio, NR, which may also be known as fifth generation, 5G, radio access technology and MulteFire. For example, in the context of LTE, BS 20 may be referred to as evolved NodeB, eNB, while in the context of NR, BS 20 may be referred to as Next Generation, NG, NodeB, gNB. In any case, embodiments are not restricted to any particular wireless technology. Instead, embodiments may be exploited in any beam-based wireless communication system. The physical link from a UE 10 to the BS 20 is called uplink (UL) or reverse link and the physical link from the BS 20 to the UE 10 is called downlink (DL) or forward link. The BS 20 may also be referred to as a network node, an access point, a distributed unit, DU, a DU part of the IAB node, or any other type of interfacing device including a relay station capable of operating in a wireless environment. It should be appreciated that network nodes or their functionalities may be implemented by using any node, host, server or access point etc. entity suitable for such a usage.

A communications system typically comprises more than one network node in which case the network nodes may also be configured to communicate with one another over links, wired or wireless, designed for the purpose. These links may be used for signalling purposes. The network node is a computing device configured to control the radio resources of the communication system it is coupled to. The network node includes or is coupled to transceivers. From the transceivers of the network node, a connection is provided to an antenna unit that establishes bi-directional radio links to user devices. The antenna unit may comprise a plurality of antennas or antenna elements. The network node is further connected to core network, CN, or next generation core, NGC. Depending on the system, the counterpart on the CN side can be a serving gateway, S-GW, routing and forwarding user data packets; packet data network gateway, P-GW, for providing connectivity of user devices, UEs, to external packet data networks; or mobile management entity, MME, etc. An example of the network node configured to operate as a relay station is integrated access and backhaul node, IAB. The distributed unit, DU part of the IAB node performs BS functionalities of the IAB node, while the backhaul connection is carried out by the mobile termination, MT part of the IAB node. UE functionalities may be carried out by IAB MT, and BS functionalities may be carried out by IAB DU. Network architecture may comprise a parent node, i.e. IAB donor, which may have wired connection with the CN, and wireless connection with the IAB MT.

BS 20 may be connected, directly or via at least one intermediate node, with core network 30, such as a NG core network and/or Evolved Packet Core (EPC). The core network 30 may comprise a set of network functions. A network function may refer to an operational and/or physical entity. For example, the element 32 may be a network function or be configured to perform one or more network functions. The network function may be a specific network node or element, or a specific function or set of functions carried out by one or more entities, such as virtual network elements. Examples of such network functions include an access control or management function, mobility management or control function, session management or control function, interworking, data management or storage function, authentication function or a combination of one or more of these functions.

Core network 30 may be, in turn, coupled with another network, via which connectivity to further networks may be obtained, for example via a worldwide interconnection network. BS 20 may be connected with at least one other BS as well via an inter-base station interface, e.g. by 3GPP X2 or similar NG interface, even though in some embodiments the inter-base station interface may be absent. BS 20 may be connected, directly or via at least one intermediate node, with core network 30 or with another core network.

The communication system may to communicate with other networks, such as a public switched telephone network, PSTN, or the Internet, or utilize services provided by them, for example via a server. The communication network may also be able to support the usage of cloud services, for example at least part of core network operations may be carried out as a cloud service. The communication system may also comprise a central control entity, or a like, providing facilities for networks of different operators to cooperate for example in spectrum sharing.

5G may utilize satellite communication to enhance or complement the coverage of 5G service, for example by providing backhauling. Possible use cases are providing service continuity for machine-to-machine, M2M, or Internet of Things, IoT, devices or for passengers on board of vehicles, or ensuring service availability for critical communications, and future railway/maritime/aeronautical communications. Satellite communication may utilise geostationary earth orbit, GEO, satellite systems, but also low earth orbit, LEO, satellite systems, in particular mega-constellations (systems in which hundreds of (nano) satellites are deployed). Each satellite in the constellation may cover several satellite-enabled network entities that create on-ground cells. The on-ground cells may be created through an on-ground relay node or by a gNB located on-ground or in a satellite

The user device, or user equipment UE, typically refers to a portable computing device that includes wireless mobile communication devices operating with or without a subscriber identification module, SIM, including, but not limited to, the following types of devices: a mobile station, mobile phone, smartphone, personal digital assistant, PDA, handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things, IoT, network which is a scenario in which objects are provided with the ability to transfer data over a network without requiring human-to-human or human-to-computer interaction.

Additionally, although the apparatuses have been depicted as single entities, different units, processors and/or memory units may be implemented inside these apparatuses, to enable the functioning thereof.

5G enables using multiple input-multiple output, MIMO, technology at both UE and gNB side, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, virtual reality, extended reality, augmented reality, different ways of data sharing and various forms of machine type applications (such as (massive) machine-type communications, mMTC), including vehicular safety, different sensors and real-time control. 5G is expected to have multiple radio interfaces, namely below 7 GHz, cmWave and mmWave, and also being integratable with existing legacy radio access technologies, such as the LTE. Below 7 GHz frequency range may be called as FR1, and above 24 GHz (or more exactly 24-52.6 GHz) as FR2, respectively. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 7 GHz-cmWave, below 7 GHZ-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

Narrowband New Radio, NB NR may support a spectrum of less than 5 MHz. This may be an emerging scenario, driven by future of the railway communications globally, smart grid operations in the USA and public safety in Europe, for example. Many other future scenarios, like machine type communication or smart phone for special bandwidth, may benefit of NB NR. Smart grids aim to use NB NR and two times 3 MHz frequency division duplex bands, FDD in 900 MHZ. Public safety implementation in Europe aims to use NB NR and two times 3 MHz FDD in band 28 for Public Protection and Disaster Relief, PPDR. A Future Railway Mobile Communication System, FRMCS, aims to use NB NR and two times 5.6 MHz frequency division duplex bands, FDD, of 874.4-880 MHZ and 919.4-925 MHz. The used Global System for Mobile Communications-Railway, GSM-R, is an international wireless communications standard for railway communications and applications. For soft migration from GSM-R parallel operation of GSM-R and NR are to be implemented. Simultaneous operation of NR and GSM-R may be implemented within 5.6 MHz by arranging NR and GSM-R channels adjacent with each other, by overlaying the channels with compact GSM-R channel, by overlaying channels with GSM-R channels distributed over 4 MHz core band, or by overlaying the channels with GSM-R channels distributed over full extended railways, ER-GSM band. Adjacent arrangement of the NR and GSM-R channels enable relatively simple and predictable co-existence of the channels, since only one boundary between the channels is introduced. Adjacent arrangement may provide easier implementation compared to other alternatives for NR scheduler.

NR uses a multiple access scheme, an orthogonal frequency domain multiple access, OFDMA, with flexible subcarrier spacing, SCS. The system may select SCS values based on carrier frequency, use-case, scenario, and/or requirements. The SCS is configured using higher layer signaling. SCS configuration identifies a frame structure. Twelve subcarriers of a certain SCS form a physical resource block, PRB. The PRB is used as a unit in frequency domain resource allocation for channels and/or signals. Fourteen OFDMA symbols for the given SCS from a slot, which is a time unit recognized by a user equipment, UE. A 1 ms subframe comprises a number of slots-one slot with 15 kHz SCS, two slots with 30 kHz SCS, and so on—and ten subframes form a radio frame. NR is designed to allow a UE to use smaller bandwidth than the system bandwidth. A UE bandwidth part, BWP, within a carrier is configured by a base station, gNB, as the number of contiguous physical resource blocks, PRBs, within an associated SCS. A UE may be configured with up to four BWPs, where BWPs may have different SCSs and may be mutually overlapping or non-overlapping in frequency. If more than one BWP is configured for a UE, the base station, gNB, may select which BWP is active at a given time. The base station may dynamically adjust the UE bandwidth according to the amount or profile of data traffic for the UE. This may be done separately for UL and DL.

Network, NW, is configured to define physical resources for transmitting downlink control information, DCI, and set of physical resource candidates for UE to monitor. Data and signaling in NR are carried in downlink, DL, and uplink, UL, physical channels. A physical downlink control channel, PDCCH, is used for carrying DCI. DCI comprises scheduling information for the UL or DL data channels and other control information for one or more UEs. DCI is processed in order to constitute a PDCCH payload. If the size of DCI format is less than 12 bits, it is appended until the payload size equals to 12 bits. A 24-bit cyclic redundancy check, CRC, is calculated for the DCI payload bits, and appended to the payload. After CRC is attached, the last 16 CRC bits are masked with a radio network temporary identifier, RNTI. Using RNTI mask the UE is able to detect the DCI for its unicast data and distinguish sets of DCI with different purposes that have the same payload size. The CRC attached bits are interleaved in order to distribute the CRC bits among the information bits. The bit are encoded in order to protect the DCI against errors during transmission, processed using a sub-block interleaver and then rate matched to fit the allocated payload resource elements, REs, of DCI. The payload bits of each DCI are separately scrambled by a scrambling sequence, which may be initialized by the physical layer cell identity of the cell, or by the UE specific scrambling identity and a UE specific cell RNTI. The scrambled DCI bit sequence is modulated, or quadrature phase shift keying, QPSK, modulated, and the complex-valued modulation symbols are mapped to physical resources in units of control channel elements, CCEs. Each control channel element, CCE, comprises six resource element groups, REGs. A REG corresponds to one PRB in one OFDM symbol, which contains nine REs for the PDCCH payload and three demodulation reference signal, DMRS, REs. For each DCI, 1, 2, 4, 8 or 16 CCEs can be allocated. The number of CCEs for a DCI is called aggregation level, AL.

A DCI with its AL is mapped to physical resources in a given BWP. Parameters, like frequency and time domain resources, and scrambling sequence identity for the DMRS for the PDCCH are configured to a UE by means of a control resource set, CORESET. CORESET comprises a set of physical resources and a set of parameters used for carrying PDCCH/DCI. A UE may be configured with up to three CORESETs on each of up to four BWPs on a serving cell. CORESET with index 0, or CORESET #0, is a CORESET different from the other ones. CORESET #0 is used, for example, for transmitting PDCCH for system information block type1, SIB1, scheduling. The PDCCH carries initial access information as it contains downlink control information, DCI, for a system information block, SIB1, scheduling. System information, SI, in NR comprises a master information block, MIB, and a number of system information blocks, SIBs. Minimum SI is configured to carry basic information required for initial access and for acquiring any other SI. Minimum SI includes MIB and SIB1. SIB1 is configured to carry information required for a UE to access a cell, like random access parameters. SIB1 includes information regarding availability and scheduling of other SIBs. Further, SIB1 includes radio resource configuration information that is common to all UEs and cell barring information applied to the unified access control. SIB1 is transmitted on the down link shared channel, DL-SCH, (logical channel: broadcast control channel, BCCH), with a periodicity, for example of 160 ms, and variable transmission repetition periodicity within 160 ms. SIB1 is a cell specific SIB. A UE obtains information for decoding SIB1 from MIB. CORESET #0 configuration is restricted to a limited number of combinations of parameters compared to other CORESETS having indexes different from zero. CORESET #0 is configured using a four-bit information element in the master information block, MIB, with respect to the cell-defining synchronization signal and physical broadcast channel, PBCH, block, SSB. CORESET #0 is acquired before higher-layer configurations are provided, for example, before a radio resource control, RRC, message is delivered. A frequency domain resource of CORESET #0 is determined relatively with the SSB. CORESETs are active only when their associated BWP is active, with the exception of CORESET #0 associated with the initial BWP with index 0. CORESET #0 is configured by a separate process and predefined parameters, as illustrated in the following Table 1.

TABLE 1

| Parameters | Predefined value or process |
|---|---|
| Frequency/Time | MIB pdcch-ConfigSIB1 (38.213-13) |
| Resource Allocation | |
| Interleaving | Assumed Interleaving (38.211-7.3.2.2) |
| L (REG Bundle Size) | 6 (38.211-7.3.2.2) |
| R (Interleaver Size) | 2 (38.211-7.3.2.2) |
| N_shift (Shiftindex) | N_cellID (38.211-7.3.2.2) |
| Cyclic Prefix | Normal (38.211-7.3.2.2) |
| Precoding | Same Precoding used in REG Bundle |
| | (38.211-7.3.2.2) |

A frequency/time resource allocation is provided by MIB or PBCH by means of index. Considerations of narrowband NR scenarios include multiplexing pattern 1, as presented in the following Table 2, where SCS is 15 kHz for both SSB and CORESET #0. Most likely number of PRBs is 24 with two or three OFDM symbols, i.e. indexes 0-5 of the following Table 2 for narrowband NR.

TABLE 2

| | SSB block | | | |
|---|---|---|---|---|
| | and CORESET | | | |
| | multiplexing | Number of | Number of | Offset |
| Index | pattern | RBs | Symbols | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |

| | |
|---|---|
| 15 | Reserved |

In order for UE to decode PDCCH/DCI, it has to figure out the exact value for location, like a CCE index, structure, like aggregation level and interleaving, and a scrambling code, like RNTI, among other. Such information is not informed to UE beforehand and in most cases those values change dynamically. A UE may have the information about a certain range that possibly carries PDCCH (DCI). A UE is informed about this certain range information by a predefined rule or signaling message. Within the informed range, the UE is configured to try to decode PDCCH/DCI using several different types of parameters and trial and error method. This way of decoding is called blind decoding. The predefined region in which a UE is configured to perform the blind decoding is called search space. PDCCH monitoring refers to blind decoding of PDCCH/DCI on the associated search space. A common search space, CSS, is a search space that multiple UEs are configured to search for signals for every UE, for example PDCCH for SIB, or signaling messages that are applied to every UE before a dedicated channel is established for a specific UE, for example PDCCH used during random access channel, RACH process. For example, a UE is configured to detect PDCCH for SIB1 scheduling.

Type0-PDCCH CSS is one of the NR PDCCH search spaces that is dedicated to transmit the PDCCH for SI message (SIB). A UE monitors Type0-PDCCH for SIB1 scheduling in slots according to selected SSB index. Corresponding to each SSB index, there are two PDCCH monitoring occasions in two consecutive slots every 20 ms for a base station, gNB, transmission of Type0-PDCCH in CORESET #0, as configured in MIB.

Table 2 shows set of resource blocks and slot symbols of CORESET for Type0-PDCCH search space set when SCS for both SS/PBCH block and PDCCH is 15 kHz for frequency bands with minimum channel bandwidth of 5 MHz or 10 MHz. The maximum number of PDCCH candidates monitored per PDCCH occasion are shown in the following table 3 for Type0-PDCCH search space set.

TABLE 3

| CCE | Number of |
|---|---|
| Aggregation Level | Candidates |
| 4 | 4 |
| 8 | 2 |
| 16 | 1 |

FIG. 2 shows, by way of example, NR synchronization signal block, SSB. The FIG. 2 comprises 15 kHz subcarrier spacing. Total bandwidth is 3.6 MHz, which is shared to 2.16 MHz bandwidth 204 and two 0.72 MHz bandwidths 203, 205. Primary synchronization signal, PSS, and secondary synchronization signal, SSS, 206 include 127 subcarriers, edge portions 203 and 205 48 subcarriers, i.e. 4 PRBs of indexes 0-3 and 16-19, correspondingly, and middle portion 204 144 subcarriers, i.e. 12 PRBs of indexes 4-15. Four ODFM symbols 202 are presented and total of 240 subcarriers, i.e. 20 PRBs 201 employed.

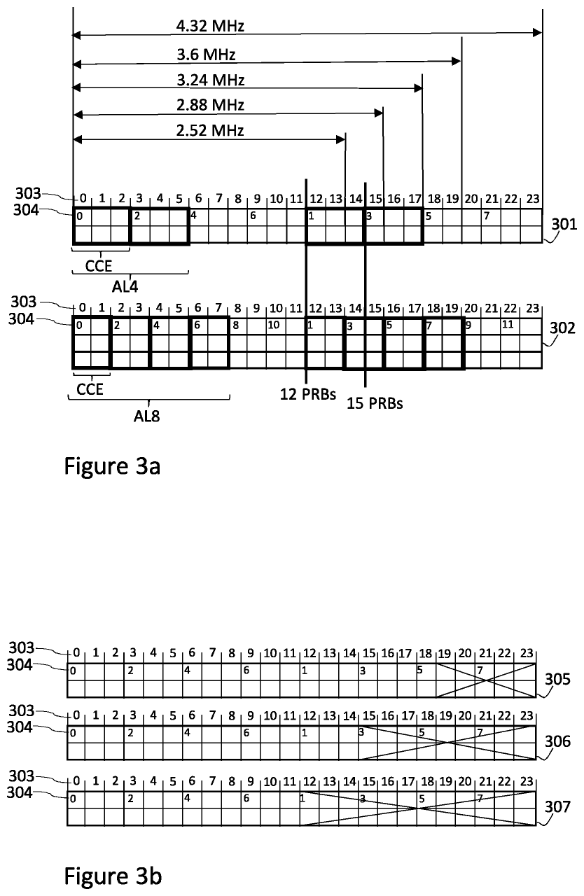

As shown in FIG. 2, an SSB occupies 20 PRBs in NR system. On the other hand, usage of 3 MHz to would mean at maximum 15 PRB, assuming that 90% of the spectrum is utilized. This leads to puncturing of at least 5 PRBs from the SSB such that the PSS and the SSS shall remain unaffected. So, maximum puncturing of 4 PRBs at both ends (203, 205 in FIG. 2) can take place. From the 20 PRBs the puncturing of 5 PRBs may be implemented by removing part of outer PRBs of indexes 0-3 or 16-19 (discussed in more detail with FIG. 3). Maximum number of punctured PRBs by a side is 4. Therefore in total 4+4=8 PRBs may be punctured from the SSB. In this case maximum total of punctured PRBs, in order to reach 15 PRBs, is 5. This may be implemented in total of 5 according to puncturing patterns (1+4), (2+3), (3+2) and (4+1), correspondingly. A punctured SSB enables to narrow down the transmission bandwidth of a base station, gNB, in order to match the available bandwidth.

A UE is configured to detect the PSS and SSS. Based on the detected PSS and SSS, the UE has information on the physical cell identifier. The UE is configured to determine resource elements, REs, for the physical broadcast channel, PBCH, demodulation reference signal, DMRS, and data to receive PBCH payload. PBCH carries master information block, MIB, which is configured to signal system information related to the frequency position and timing. The frequency position means synchronization signal PBCH block, SSB, frequency domain allocation related to a common resource block, CRB, grid. Synchronization signal block and PBCH are configured to be transmitted/received in combination, so it those are referred to and called as one block, called a synchronization signal PBCH block or SS/PBCH block, SSB. In other words, SSB comprises PSS, SSS and PBCH. The timing may include a slot timing, a half frame timing and a frame timing. The information is contained either in higher layer payload, i.e. MIB, as part of the physical layer bits in the transport block payload, or in DRMS. FIG. 3a shows, by way of an example, a 2-symbol CORESET #0 301 and a 3-symbol CORESET #0 302 with 24 PRBs. Bandwidths are illustrated on top including 4.32 GHZ (24 PRBs), 3.6 GHZ (20 PRBs), 3.24 GHz (18 PRBs), 2.88 GHZ (16 PRBs) and 2.52 GHz (14 PRBs). Number of PRBs is 24, as illustrated by indexes 0-23, referred as 303 in FIG. 3a, and the number of OFDM symbols is two 301 or three 302. CCE of three or two symbols are numbered and interleaved, as illustrated in FIG. 3. CCEs of the 2-symbol CORESET #0 301 have index numbers 304 from 0 to 7, and CCEs of the 3-symbol CORESET #0 302 have index numbers 304 from 0 to 11. Aggregation level, AL, of the CORESET #0 301 is AL4, and of the CORESET #0 302 AL8. Interleaved CCEs are distributed in a frequency domain such that those are configured to span across all OFDM symbols for a certain CORESET. In non-interleaved mapping all CCEs for a DCI would be mapped to REs in a consecutive manner. With aggregation level, AL, 4, the maximum number of PDCCH candidates monitored per PDCCH occasion is four. As FIG. 3 illustrates, using 15 PRB allocation, aggregation level, AL, 4 for the Type0-PDCCH transmitted on CORESET #0 and comprising indexes 0-3 cannot be supported without puncturing. With 12 PRBs, which is the smallest achievable transmission bandwidth in order to maintain PSS/SSS untouched, AL4 transmission, of 3-symbol CCEs 302, can be supported. This may be punctured down to two CCEs.

FIG. 3b shows examples of a punctured CORESET. FIG. 3b shows 2-symbol CORESET with interleaved CCEs 304 and 24 PRBs 303. FIG. 3b shows PDCCH with AL8 has been punctured to 6 CCEs 305, to 5 CCEs 306 and to 4 CCEs 307. A CORESET is configured to define a search space for a PDCCH. The PDCCH transmitted via the CORESET may be punctured. Puncturing enables to reduce PDCCH bandwidth. Puncturing is a simple operation for a base station, where predefined PRBs are simply blanked. No further processing, like remapping or redesign, is required for the punctured PDCCH. Puncturing is applicable in the context of non-interleaved CCE mapping as well.

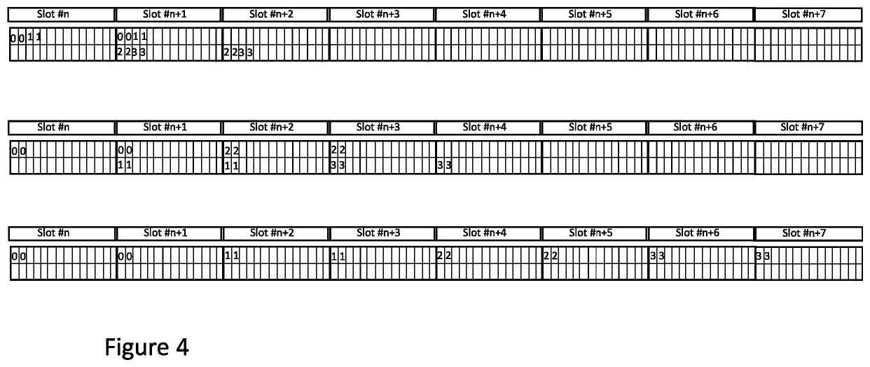

FIG. 4 shows, by way of an example, Type0-PDCCH monitoring occasions. A UE is configured to monitor Type0-PDCCH occasions according to selected SSB index. FIG. 4 shows monitoring occasions in 15 kHz SCS in frequency range 1, FR1, referring from sub to 6 GHz frequency bands allocated to 5G. SSB-CORESET #0 multiplexing pattern 1 is used. Multiplexing pattern 1 means that SSBs and associated PDCCH monitoring occasions are time division multiplexed. In addition, the SSB is located within the bandwidth defined by the bandwidth of the CORESET #0. In other words, the SSB and the CORESET #0 are overlapping in a frequency domain. Frequency domain is 24 PRB CORESET #0. Two symbol time domain allocation is utilized with different offset, O, from the beginning of the radio frame. The offset values include 0, 2, 5, 7. M values (½, 1 and 2 from top down) illustrate a slot offset factor between monitoring occasions of different SSB indexes. Alternatively, M values illustrate how compactly monitoring occasions of different SSBs are allocated in the time domain. Monitoring occasions of 2-symbol Type0-PDCCH associated with SSB #0 are marked with “00”, associated with SSB #1 are marked with “11”, associated with SSB #2 are marked with “22” and associated with SSB #3 are marked with “33” in FIG. 4. Each SSB has two consecutive slots every 20 ms in which a base station may transmit Type0-PDCCH in CORESET #0. A base station is not mandated to transmit a Type0-PDCCH at the monitored slots. The same principle applies for CORESET #0 having 24 PRBs and three symbol allocation. Both, two- and three symbol allocations are supported for 24 PRB frequency domain allocation, as illustrated in the previous Table 2, the first six lines, referring to indexes 0-5.

PDCCH candidates to be monitored by a UE are configured for the UE by search space sets, SS. A common search space, CSS, is monitored by a group of UEs in a cell. A UE-specific search space, USS, is monitored by an individual UE. A CSS set having index 0, SS set 0, is configured using four bit information element in a MIB with respect to a cell defining SSB. SS set 0 is monitored before higher-level configurations are provided. Its configuration is restricted to a limited number of combinations of parameters compared to other SSs, having set different from zero. PDCCH search space refers to the area in the downlink resource grid, where PDCCH may be carried. UE may be configured to perform blind decoding throughout the PDCCH search space in order to try to find PDCCH data (i.e, DCI). At high level, NR search space concept is similar to LTE search space, but there are many differences in terms of the detail.

Identity of a search space, SS, may be determined by a SearchSpaceId parameter. SearchSpaceId parameter value 0 identifies the SearchSpace configured via PBCH/MIB or ServingCellConfigCommon. The SearchSpaceId is unique among the BWPs of a serving cell. CORESET applicable for the SS may be identified using controlResourceSetId. Value 0 identifies the common CORESET configured in MIB and in ServingCellConfigCommon. Type0-PDCCH CSS is a subset of NR PDCCH SS that is dedicated to transmit the PDCCH for SI message, i.e. SIB. Number of PRBs and OFDM symbols assigned for a CORESET may be identified in controlResourceSetZero parameter, which is part of RRC parameters defining CORESET #0, and from a CORESET #0 position in a frequency domain. Parameter searchSpaceZero indicates which OFDM symbols to monitor in order to search the CORESET #0 and on which slots the CORESET #0 may be transmitted. One parameter defining the CSS may be MIB.pdcchConfigSIB1.

The UE may be configured to determine that a special configuration is applied for the Type0-PDCCH. The determination may be based on a certain synchronization raster point, on which the UE detected the SSB, on information carried on PBCH/MIB, or on prior information regarding the RF channel in question. The information carried on PBCH/MIB may comprise one bit information by re-interpreting certain existing field, like subCarrierSpacingCommon field, or half slot indication. The fields are re-interpreted in response to a UE detecting SSB in certain band or synchronization raster point. Detection of the SSB includes the UE detecting PSS/SSS and determining the SSB index from PBCH DMRS. The bands may include NR bands n8, n26, n28, as presented in the following Table 4, or FRMCS scenario of approximately 900 Mhz.

TABLE 4

| NR | Duplex | | | f, UL | f, DL |
|---|---|---|---|---|---|
| Band | mode | f (MHz) | f (MHz) | (MHz) | (MHz) |
| | FDD | 900 | RMR900 | 874.4-880 | 919.4-925 |
| | | | (Rail Mobile | | |
| | | | Radio) | | |
| n8 | FDD | 900 | Extended GSM | 880-915 | 925-960 |
| n26 | FDD | 850 | Extended CLR | 814-849 | 859-894 |
| | | | (Cancel-Location- | | |
| | | | Request) | | |
| n28 | FDD | 700 | APT | 703-748 | 758-803 |
| | | | (Asia-Pasific | | |
| | | | Telecommunity) | | |

In case a special configuration, applied for the Type0-PDCCH, is determined, the UE is configured to determine an extended search space set. The extended search space set for Type0_PDCCH is configured to contain CCEs from two or more CORESET #0. The extended search space set comprises two or more CORESETs (#0) span on certain resources in a frequency domain. In these cases, the UE may combine two or more predefined PDCCH candidates, with a certain aggregation level, for example AL8, from two or more CORESET #0 in order to form an aggregated PDCCH. The combining may be done at different phases. For example, at the output of a polar decoder for soft bits, or at the input of a polar encoder for soft bits, or before polar encoding for (soft) modulation symbols.

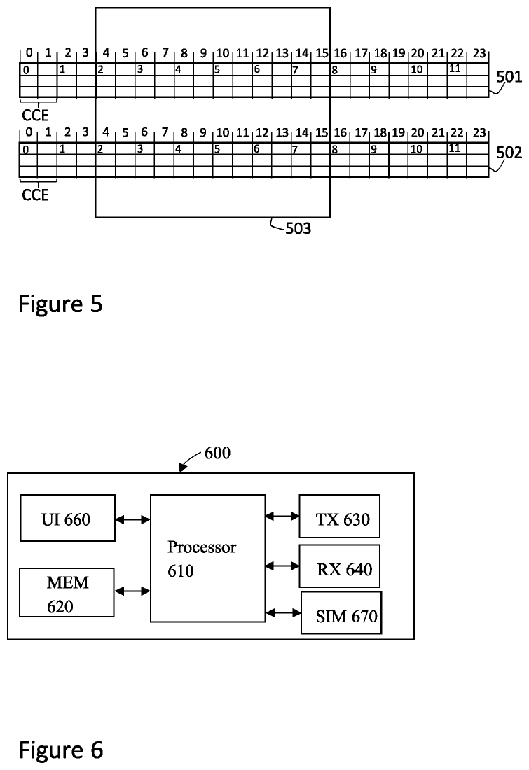

FIG. 5 shows, by way of an example, an extended search space set for Type0-PDCCH. CORESETs (#0) are non-interleaved. The extended search space set 503 contains CCEs from both CORESET #0. CCEs from CORESETs (#0) are associated to two different SSB indexes. CORESET #0 associated to SSB index #A 501 and CORESET #0 associated to SSB index #B 502. From each CORESET #0, the CCEs that are overlapping with the predefined transmission bandwidth are identified. Thus, the UE may know the actual transmission bandwidth of the base station, gNB, or it may operate in accordance to minimum bandwidth hypothesis. The UE may try PDCCH detection for certain aggregation level, for example AL8, with multiple bandwidth hypothesis, i.e. multiple puncturing patterns. The overlapping CCEs, CCEs 2-7 in FIG. 5, correspond to PRBs occupied by PSS/SSS. According to non-interleaved CCE mapping there are 6 overlapping CCEs. The arrangement may be created for example from punctured AL 8 starting from CCE #0 in FIG. 5. In other words, the puncturing may cover CCE indexes #0 and #1, which means that a UE may consider CCE indexes #2-#7.

CORESET #0 may comprise size of 3 OFDM symbols in time and 24 PRBs in frequency, as shown, by way of an example, in the FIG. 5. With PRB value of zero, CORESET #0 and SSB are aligned. Transmission bandwidth for Type0-PDCCH is 12 PRBs in the illustrated example. PRBs are fully aligned with PSS/SSS. In other examples, PBCH and PDCCH may occupy other number of PRBs, for example 15 PRBs. In other examples, where number of PRBs is greater than 12, PRBs are overlapping with PSS/SSS that have bandwidth of 12 PRBs. Thus, PSS/SSS are within the bandwidth of the resources associated to the extended search space set.

When an extended search space set has been determined, the UE is configured to monitor Type0-PDCCH using the extended search space set. Monitoring and/or detection of DCI of Type0-PDCCH with ALs 16, 8, 4 is implemented. Alternatively, punctured versions of ALs 16, 8, 4 may be employed. The extended search space set includes a determined number of valid CCEs.

In response to detecting PDCCH scrambled with SI-RNTI in the extended search space set, the UE is configured to determine a last-in-time monitoring occasion of the associated occasions. The last-in-time corresponds to a monitoring occasion that ends at the latest in time. The determined last end time of the monitoring occasions, which is then used as a time reference. The time reference may be used for physical DL control channel, PDSCH, allocation. A time domain resource allocation of the PDSCH is counted from the end fo the last-in-time CORESET #0 of the extended search space set of CORESETS (#0).

With the provided extended search space set, PDCCH performance reduction of approximately 7 dB for 12 PRB scenario, compared to a baseline AL 8, and almost 9 dB compared to AL 16, may be reduced or avoided. One reason behind previous performance levels is interleaved CCE mapping, which is always used for CORESET #0. For dedicated CORESETs, other than CORESET #0, interleaved CCE mapping can be switched off. This allows up to 6 CCEs when using three symbol CORESETs, and 12 PRBs.

In case a special configuration of Type0-PDCCH is detected, there are alternative ways to determine an extended search space set. If a UE is configured to read from Type0-PDCCH configuration that value M equals to ½, the UE is configured to determine that monitoring occasions associated to two SSBs, that are mapped into a same slot, are comprised in the extended search space set in terms of CCEs. The CCEs are may be spanned across CORESETs (#0). Valid CCEs per CORESET #0 may be the ones that are allocated upon PRBs that the base station is actually transmitting. Valid CCEs may be the ones that are overlapping in frequency domain, for example with the center 12 PRBs of the SSB. In some scenario, the UE may have prior information that 15 PRBs with certain puncturing pattern of the SSB is transmitted. The UE may be configured to determine valid CCEs being allocated on the determined 15 PRBs. Prior information may indicate that the SSB is puncturing patterns of SSB. For example, that the SSB is punctured by one PRB at the top and four PRBs at the bottom. Alternative puncturing patterns, which enable 15 PRBs to be transmitted, include (1+4), (2+3), (3+2), (4+1). In this scenario, the base station may operate using at the most two beams.

Another alternative for determining an extended search space set is that the UE is configured to combine all search space sets of the monitoring occasions associated to four SSBs. The UE may assume that the base station operates using a single beam and transmits SSB in each four SSB location. The UE may assume that the valid CCEs in the CORESETs (#0) are the ones that are allocated upon PRBs the base station is actually transmitting. Alternatively, the UE may assume that valid CCEs are the ones that are overlapping in frequency domain with the center 12 PRBs of the SSB.

The UE assumes a PDCCH combining pattern which is associated to the puncturing pattern. According to the PDCCH combining patterns, the UE is configured to determine monitoring occasions, associated to certain SSBs that have an extended search space set comprising CCEs across the associated CORESETs (#0). In frequency domain, the CCEs that are fully within PRBs the base station is actually transmitting, SSBs according to the puncturing pattern are considered valid. In case no puncturing exists, it may be predetermined that valid CCEs are either the CCEs overlapping with SSBs in the frequency domain, or all CCEs of the configured CORESET #0.

The puncturing pattern may indicate puncturing of both SSB and CORESET #0 or puncturing of CORESET #0 only. The indication may be done via reserved bits in PBCH, or by re-interpreting PBCH bits not used with the considered special configuration, or the indication may be encoded to PBCH DMRS sequence and/or pattern.

For enabling an extended search space set to be formed or determined, the UE may assume that subset or all of the transmitted SSBs share the same quasi co-location, QCL. The UE may assume that SS/PBCH blocks transmitted with the same block index on the same center frequency location are quasi co-located with respect to Doppler spread, Doppler shift, average gain, average delay, delay spread, and when applicable, spatial Rx parameters. The UE may determine this QCL information form the specific synchronization raster point detected from PSS/SSS or from certain RF channel. QCL information may be determined from pre-configured information or from reading form the PBCH/MIB after the first SSB detected. The assumption on QCL is applicable for the considered scenarios where one-beam operation is the baseline for the initial access.

Monitoring occasions of the Type0-PDCCH associated to different SSBs are associated so that the UE is able to combine an extended search space set to include search spaces of CCEs from two or more associated CORESETs (#0). In other words, the base station transmits Type0-PDCCH in monitoring occasions defined by different SSBs. The Type0-PDCCHs are configured to form together one CCE space which is defined by the actually transmitted PRBs in both/all CORESETs (#0). Transmitted PRBs may be defined in PBCH/MIB or there may be some other indication for puncturing pattern for the SSBs and thus effective channel bandwidth. According to an alternative, an extended search space set may comprise combination of CORESETs (#0) based on 12 PRBs occupied by PSS/SSS. This enables removing the uncertainty relating to BW detection.

In case monitoring occasions are in the same slot, or within a certain time window, MIB may provide Type0-PDCCH repetition configuration. For example, parameter values, e.g. of 1, 2, 4, may be included, of which value 1 indicates no repetition and no extended search space set to be formed; value 2 indicates monitoring occasions associated to SSB #0 and SSB #1 can be combined and form an extended search space set. The same applies similarly to SSB #2 and SSB #3 pair. Value 4 indicated monitoring occasions associated to SSB #0, SSB #1, SSB #2, SSB #3 can be combined and form an extended search space set. Another option is that Type0-PDCCH repetition configuration is predetermined, like hard-coded, and associated to the indicated or detected puncturing pattern. In case no puncturing pattern exists, there is no repetition and no extended search space set is formed. In case SSB puncturing pattern of a first predetermined value, for example 15 PRBs, exists, monitoring occasions associated to SSB #0 and SSB #1, and correspondingly SSB #2 and SSB #3, can be combined and a corresponding extended search space set formed. In case SSB puncturing pattern of a second predetermined values, for example 12 PRBs, exists, monitoring occasions associated to SSB #0, SSB #1, SSB #2 and SSB #3 can be combined and the corresponding extended search space set formed.

In another option, Type0-PDCCH repetition configuration is hard-coded in the specs, for example it may be switched on for a certain synchronization raster points and/or for 15 kHz when operating at certain bands, for example n8, n26 or n28. This alternative option does not require puncturing pattern or effective channel bandwidth indication, for example in MIB.

Yet another option comprises a predetermined, for example hard coded, Type0-PDCCH repetition configuration, which is associated to the indicated or detected puncturing pattern. In case no SSB puncturing exists, there is no repetition and no extended search space set is formed. In case SSB puncturing pattern of a first predetermined value, like 15 PRBs, exists, monitoring occasions associated to SSB #0 and SSB #1, as well as to pair SSB #2 and SSB #3, can be combined and form an extended search space set. In case SSB puncturing pattern of a second predetermined value, like 12 PRBs, exists, monitoring occasions associated to SSB #0, SSB #1, SSB #2 and SSB #3 can be combined and form an extended search space set.

When a UE is configured to combine two or more CORESETS (#0), it may assume that the corresponding CCEs are created according to non-interleaved CCE mapping. Another approach comprises using interleaved CCE mapping at least for CORESET #0. In case the UE is configured to monitor Type0-PDCCH from a certain band or raster point, the UE may assume that it does not need to monitor Type0-PDCCH with AL8 and/or AL16. The available PDCCH monitoring capacity may be used for detecting Type0-PDCCH from multiple CORESETs (#0). This may be assuming that PDCCH repetition, optionally over predefined Type0-PDCCH monitoring occasions associated to different SSBs; assuming specific PRBs, for example 12 PRBs occupied by SSS/PSS or PRBs determined based on detected PBCH BW; and/or assuming non-interleaved CCE mapping. The UE may monitor repeated PDCCH, the first transmission, in a single-shot manner, in addition. This way repetition may become optional for the base station.

It may be assumed, alternatively or in addition to any of the previous, that the Type0-PDCCH payload and CCEs are kept constant between each associated Type0-PDCCH monitoring occasions. In certain cases, the associated Type0-PDCCH monitoring occasions are the ones, where the UE may assume the QCL source to be the same. Alternatively, the UE may assume the Type0-PDCCH payload to be the same for all Type0-PDCCH monitoring occasions. The corresponding PDSCH transmission may occur in corresponding manner based on each Type0-PDCCH.

In the previous, Type0-PDCCH is used for a search space of a control resource set. PDCCH schedules PDSCH, which carries SIB as payload of the PDSCH. A UE is configured to monitor PDCCH transmitted with SI-RNTI in order to detect DCI that schedules PDSCH transmission, which carries SIBx payload.

FIG. 6 shows, by way of example, a block diagram of an apparatus. An apparatus being capable of monitoring a search space set. Illustrated is a device 600, which may comprise, for example, a mobile communication device such as UE 10 of FIG. 1. A device 600 comprises a processor 610, which may comprise, for example, a single- or multi-core processor wherein a single-core processor comprises one processing core and a multi-core processor comprises more than one processing core. The processor 610 may comprise, in general, a control device. The processor 610 may be a control device. The processor 610 may comprise more than one processor unit or processing core. A processing core may comprise, for example, a Cortex-A8 processing core manufactured by ARM Holdings or a Steamroller processing core designed by Advanced Micro Devices Corporation. The processor 610 may comprise at least one Qualcomm Snapdragon and/or Intel Atom processor. The processor 610 may comprise at least one application-specific integrated circuit, ASIC. The processor 610 may comprise at least one field-programmable gate array, FPGA. The processor 610 may be means for performing method steps in device 600. The processor 610 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

A device 600 may comprise a memory 620. The memory 620 may comprise random-access memory and/or permanent memory. The memory 620 may comprise at least one RAM chip. The memory 620 may comprise solid-state, magnetic, optical and/or holographic memory, for example. The memory 620 may be at least in part accessible to the processor 610. The memory 620 may be at least in part comprised in processor 610. The memory 620 may be means for storing information. The memory 320 may comprise computer instructions that the processor 610 is configured to execute. When computer instructions configured to cause a processor 610 to perform certain actions are stored in a memory 620, and a device 600 overall is configured to run under the direction of the processor 610 using computer instructions from the memory 620, the processor 610 and/or its at least one processing core may be considered to be configured to perform said certain actions. The memory 620 may be at least in part external to the device 600 and accessible to the device 600.

The device 600 may comprise a transmitter 630. The device 600 may comprise a receiver 640. The transmitter 630 and the receiver 640 may be configured to transmit and receive, respectively, information in accordance with at least one cellular or non-cellular standard. The transmitter 630 may comprise more than one transmitter unit. The receiver 640 may comprise more than one receiver unit. The transmitter 630 and/or the receiver 640 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

The device 600 may comprise a near-field communication, NFC, transceiver. The NFC transceiver may support at least one NFC technology, such as NFC, Bluetooth, Wibree or similar technologies.

The device 600 may comprise a user interface, UI, 660. The UI 660 may comprise at least one of a display, a keyboard, a touchscreen, a vibrator arranged to signal to a user by causing the device 600 to vibrate, a speaker and a microphone. A user may be able to operate the device 600 via the UI 660, for example to accept incoming telephone calls, to originate telephone calls or video calls, to browse the Internet, to manage digital files stored in the memory 620 or on a cloud accessible via the transmitter 630 and the receiver 640, or via the NFC transceiver, and/or to play games.

The device 600 may comprise or be arranged to accept a user identity module 670. The user identity module 670 may comprise, for example, a subscriber identity module, SIM, card installable in the device 600. A user identity module 670 may comprise information identifying a subscription of a user of device 600. A user identity module 670 may comprise cryptographic information usable to verify the identity of a user of device 600 and/or to facilitate encryption of communicated information and billing of the user of the device 600 for communication effected via the device 600.

A processor 610 may be furnished with a transmitter arranged to output information from the processor 610, via electrical leads internal to the device 600, to other devices or device blocks comprised in the device 600. Such a transmitter may comprise a serial bus transmitter arranged to, for example, output information via at least one electrical lead to a memory 620 for storage therein. Alternatively to a serial bus, the transmitter may comprise a parallel bus transmitter. Likewise, the processor 610 may comprise a receiver arranged to receive information in the processor 610, via electrical leads internal to the device 600, from other devices comprised in the device 600. Such a receiver may comprise a serial bus receiver arranged to, for example, receive information via at least one electrical lead from the receiver 640 for processing in the processor 610. Alternatively to a serial bus, the receiver may comprise a parallel bus receiver.

A device 600 may comprise further devices not illustrated in FIG. 6. For example, where the device 600 comprises a smartphone, it may comprise at least one digital camera. Some devices 600 may comprise a back-facing camera and a front-facing camera, wherein the back-facing camera may be intended for digital photography and the front-facing camera for video telephony. The device 600 may comprise a fingerprint sensor arranged to authenticate, at least in part, a user of the device 600. In some example embodiments, the device 600 lacks at least one device block described above. For example, some devices 600 may lack a NFC transceiver and/or a user identity module 670.

A processor 610, a memory 620, a transmitter 630, a receiver 640, a NFC transceiver 650, a UI 660 and/or a user identity module 670 may be interconnected by electrical leads internal to a device 600 in a multitude of different ways. For example, each of the aforementioned device blocks may be separately connected to a master bus internal to the device 600, to allow for the device blocks to exchange information. However, as the skilled person will appreciate, this is only one example and depending on the embodiment various ways of interconnecting at least two of the aforementioned device blocks may be selected.

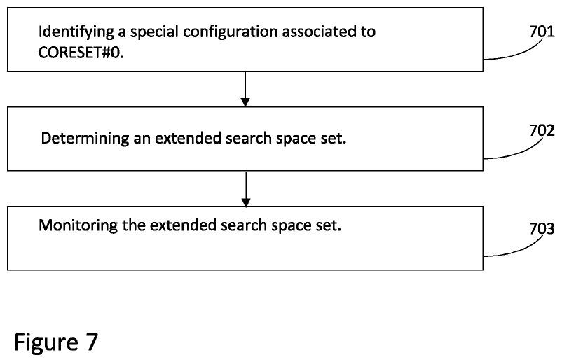

FIG. 7 shows, by way of an example, a flow chart of a method for a mobile device. Phase 701 comprises identifying, by a UE, a special configuration for at least one search space associated to a control resource set of index 0, CORESET #0. The at least one search space may comprise a physical downlink control channel of type 0, Type0-PDCCH. Based on determined special configuration, an extended search space set determining is performed at phase 702. After the extended search space set is determined or formed, it may be monitored, for example for data control information, DCI, of Type0-PDCCH at phase 703.

It is to be understood that the embodiments of the invention disclosed are not limited to the particular structures, process steps, or alternative implementations disclosed herein, but are extended to equivalents thereof as would be recognized by those ordinarily skilled in the relevant arts. It should also be understood that terminology employed herein is used for the purpose of describing particular embodiments only and is not intended to be limiting.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1-17. (canceled)

18. An apparatus, comprising:
at least one processor; and
at least one memory storing instructions that, when executed by the at least one processor, cause the apparatus at least to:
identify a special configuration for at least one search space associated to a control resource set of index 0 (CORESET #0) which is configured to carry information for initial access to a communication network; and
determine an extended search space set based on the identified special configuration.

19. The apparatus according to claim 18, wherein the apparatus is further caused to:
monitor the CORESET #0 based on the determined extended search space set.

20. The apparatus according to claim 18, wherein the at least one search space corresponds to a physical downlink control channel of type 0.

21. The apparatus according to claim 18, wherein the CORESET #0 is configured to transmit a physical downlink control channel (PDCCH) wherein the PDCCH is a punctured PDCCH.

22. The apparatus according to claim 18, wherein the apparatus is caused to identify the special configuration based on at least one of the following:
a certain synchronization raster point, on which the apparatus detected a synchronization signal block (SSB) transmitted by a base station of the communication network;
information carried on a physical broadcast channel or on a master information block (MIB); and
information regarding the radio frequency channel used.

23. The apparatus according to claim 18, wherein the apparatus is caused to determine the extended search space set to include valid control channel elements (CCEs) wherein the valid CCEs are from two or more CORESET #0, which are configured to carry scheduling information for system information.

24. The apparatus according to claim 23, wherein the valid CCEs comprise at least one or more of the following:
CCEs that a base station actually transmitted;
CCEs of two or more CORESET #0, which overlap at least partly in the frequency domain; and
CCEs allocated according to a puncturing pattern.

25. The apparatus according to claim 18, wherein
a predefined CCEs form a PDCCH candidate with one of: an aggregation level 4, an aggregation level 8 and an aggregation level 16; and
the predefined CCEs in the PDCCH candidate comprise at least one or more of the following:
interleaved mapping within the CORESET #0,
non-interleaved mapping within the CORESET #0,
valid CCEs.

26. The apparatus according to claim 18, comprising a combination of two or more PDCCH candidates from two or more CORESET #0 in order to form an aggregated PDCCH.

27. The apparatus according to claim 18, wherein
SSBs with the same block index of the same center frequency location are quasi co-located.

28. The apparatus according to claim 18, wherein the apparatus is caused to monitor the CORESET #0 in several monitoring occasions defined by different SSBs.

29. The apparatus according to claim 28, wherein the monitoring occasions comprise a repetition configuration, and at least one of the following:
the monitoring occasions are in the same slot or within a time window and a MIB is configured to provide the repetition configuration;
the repetition configuration is predetermined or hard-coded; and
the repetition configuration is associated to a puncturing pattern of the CORESET #0 alone or in combination with SSB.

30. The apparatus according to claim 18, wherein the apparatus is caused to use a bandwidth smaller than 5 MHz and/or the CORESET #0 comprises 24 physical resource blocks.

31. A method, comprising:
identifying a special configuration for at least one search space associated to a control resource set of index 0 (CORESET #0) which is configured to carry information for initial access to a communication network; and
determining an extended search space set based on the identified special configuration.

32. The method according to claim 31, further comprising:
monitoring the CORESET #0 based on the determined extended search space set.

33. The method according to claim 31, wherein the at least one search space corresponds to a physical downlink control channel of type 0.

34. The method according to claim 31, wherein the CORESET #0 is configured to transmit a physical downlink control channel, PDCCH, wherein the PDCCH is a punctured PDCCH.

35. The method according to claim 31, identifying the special configuration based on at least one of the following:
a certain synchronization raster point, on which the apparatus detected a synchronization signal block, SSB, transmitted by a base station of the communication network;
information carried on a physical broadcast channel or on a master information block (MIB); and
information regarding the radio frequency channel used.

36. The method according to claim 31, wherein determining the extended search space set to include valid control channel elements (CCEs) wherein the valid CCEs are from two or more CORESET #0, which are configured to carry scheduling information for system information.

37. A non-transitory computer readable medium comprising program instructions that, when executed by at least one processor, cause an apparatus at least to:
identify a special configuration for at least one search space associated to a control resource set of index 0 (CORESET #0) which is configured to carry information for initial access to a communication network; and
determine an extended search space set based on the identified special configuration.
